(19) United States
(12) Patent Application Publication
(10) Pub. No.: US 2011/0076066 A1
(43) Pub. Date: Mar. 31, 2011

(54) FIXING APPARATUS AND IMAGE FORMING APPARATUS

(75) Inventors: Katsuhito GOMI, Chino (JP); Yoshiyuki NAGAI, Shiojiri (JP); Kenjiro YOSHIOKA, Shiojiri (JP)

(73) Assignee: SEIKO EPSON CORPORATION, Tokyo (JP)

(21) Appl. No.: 12/841,557

(22) Filed: Jul. 22, 2010

(30) Foreign Application Priority Data
Sep. 30, 2009 (JP) 2009-226425

(51) Int. Cl. G03G 15/20

(52) U.S. Cl. 399/322; 399/341

(57) ABSTRACT

A fixing apparatus includes: a first fixing unit including a first heating unit heats to a transfer material onto which an image has been transferred and a first pressure unit that forms a first nip portion; a second fixing unit including a second heating unit heats to the transfer material fixed in the first fixing unit and a second pressure unit that forms a second nip portion; and a fixing unit suction guide, including a suction surface that sucks the transfer material fixed in the first fixing unit upward with a surface of the transfer material onto which the image has been transferred facing downward, an end of the suction surface on a side toward the second fixing unit in a transport direction of the transfer material being located higher in the vertical direction than an imaginary line that connects the first nip portion and the second nip portion.

### BACKGROUND

1. Technical Field

The present invention relates to fixing apparatuses and image forming apparatuses that handle electrophotography.

2. Related Art

A fixing device, in an image forming apparatus, that includes a first fixing unit that fixes an image transferred onto a transfer material, a second fixing unit that carries out fixing after the first fixing, and a bypass transport path in which the transfer material that has passed through the first fixing unit does not pass through the second fixing unit, has been disclosed in the past (see JP-A-2006-308889).

However, the image forming apparatus according to JP-A-2006-308889 also includes a curl application means that corrects curls arising due to heat contraction of the toner and the like and a flapper that switches transport paths, leading to an increase in the size and complexity of the apparatus.

In addition, there has been a risk that after being discharged from the first fixing unit, the transfer material sags downward in the vertical direction due to the influence of gravity; this causes the printed surface to collide with the second fixing unit, leading to the occurrence of defects in the image. Furthermore, there have been situations where rollers, the flapper, and so on have made contact with the image surface immediately after the fixing, when the image surface is still in a high-temperature state, thus leading to a different glossiness in the areas of the image where the contact was made than in the rest of the image; the quality of the image has thus dropped as a result.

### SUMMARY

An advantage of some aspects of the invention is to provide a fixing apparatus capable of reducing the influence of a second fixing unit on the surface of an image while employing a simple structure, and an image forming apparatus capable of forming a favorable image.

A fixing apparatus according to an aspect of the invention includes: a first fixing unit having a first heating unit that applies heat to a transfer material onto which an image has been transferred and a first pressure unit that forms a first nip portion by pressing against the first heating unit; a second fixing unit including a second heating unit that applies heat to the transfer material that has undergone fixing in the first fixing unit and a second pressure unit that forms a second nip portion by pressing against the second heating unit; and a fixing unit suction guide, including a suction surface that sucks the transfer material that has undergone fixing in the first fixing unit upward in the vertical direction with the surface of the transfer material onto which the image has been transferred facing downward in the vertical direction, the end of the suction surface on the side toward the second fixing unit in a transport direction of the transfer material being located higher in the vertical direction than an imaginary line that connects the first nip portion and the second nip portion.

An image forming apparatus according to an aspect of the invention includes: a latent image bearing member on which a latent image is formed; a developing unit that develops the latent image on the latent image bearing member using a liquid developer containing toner particles and a carrier liquid; a transfer medium onto which the image developed on the latent image bearing member by the developing unit is transferred; a transfer roller that makes contact with the transfer medium and forms a transfer nip portion therewith, and that transfers the image onto a transfer material; a first fixing unit having a first heating unit that applies heat to the transfer material onto which the image has been transferred and a first pressure unit that forms a first nip portion by pressing against the first heating unit; a second fixing unit having a second heating unit that applies heat to the transfer material that has undergone fixing in the first fixing unit and a second pressure unit that forms a second nip portion by pressing against the second heating unit; and a fixing unit suction guide, having a suction surface that sucks the transfer material that has undergone fixing in the first fixing unit upward in the vertical direction with the surface of the transfer material onto which the image has been transferred facing downward in the vertical direction, the end of the suction surface on the side toward the second fixing unit in a transport direction of the transfer material being located higher in the vertical direction than an imaginary line that connects the first nip portion and the second nip portion.

According to another aspect of the invention, the side of the suction surface toward the first fixing unit is parallel or approximately parallel to the imaginary line.

According to another aspect of the invention, the first fixing unit is a heating roller in which the first heating unit has an elastic layer, and the first pressure unit is a pressure roller whose surface hardness is the same or approximately the same as the surface hardness of the heating roller.

According to another aspect of the invention, the side of the suction surface toward the first fixing unit is sloped downward in the vertical direction beyond the imaginary line.

An image forming apparatus according to another aspect of the invention further includes: a transport belt that forms the suction surface and transports the transfer material that has undergone fixing in the first fixing unit; a driving roller, upon which the transport belt is wound, that drives the transport belt; and a slave roller upon which the transport belt is stretched.

According to another aspect of the invention, the transport belt has a hole through which air flows.

According to the fixing apparatus of the invention, the influence of the second fixing unit on the image surface can be reduced using a simple configuration. Meanwhile, according to the image forming apparatus of the invention, the influence of the second fixing unit on the image surface can be reduced using a simple configuration, thus making it possible to form a favorable image.

In addition, because the fixing unit suction guide, in which the end of the suction surface on the side toward the second fixing unit in the transport direction of the transfer material is located higher in the vertical direction than the imaginary line that connects the first nip portion and the second nip portion, is provided, it is possible for the transfer material to move to the nip portion of the second fixing roller pair in a smooth manner.

In addition, because the side of the suction surface toward the first fixing unit is parallel or approximately parallel to the imaginary line, the transfer material can move to the fixing unit suction guide in a smooth manner.

In addition, because the side of the suction surface toward the first fixing unit is sloped downward in the vertical direction beyond the imaginary line, the transfer material can move to the fixing unit suction guide in a smooth manner.

In addition, an image forming apparatus according to an aspect of the invention further includes the transport belt that forms the suction surface and transports the transfer material that has undergone fixing in the first fixing unit, the driving roller, upon which the transport belt is wound, that drives the transport belt, and the slave roller upon which the transport belt is stretched. As a result, the transfer material sticks to the transport belt and the transfer material and transport belt move together, and thus the transfer material can be transported from the first fixing roller pair toward the second fixing roller pair in a stable manner.

In addition, because the fixing unit transport belt includes the holes through which air flows, the transfer material can be transported in an even more stable manner.

### BRIEF DESCRIPTION OF THE DRAWINGS

The invention will be described with reference to the accompanying drawings, wherein like numbers reference like elements.

FIG. 1 is a diagram illustrating a first embodiment of an image forming apparatus.

FIG. 2 is a diagram illustrating a fixing unit suction guide according to the first embodiment.

FIG. 3 is a diagram illustrating a fixing unit suction guide according to a second embodiment.

FIG. 4 is a diagram illustrating an enlarged view of a first fixing roller pair according to the second embodiment and a third embodiment.

FIG. 5 is a diagram illustrating a fixing unit suction guide according to the third embodiment.

FIG. 6 is a diagram illustrating a fixing unit suction guide according to a fourth embodiment.

FIG. 7 is a diagram illustrating a fixing unit suction guide according to a fifth embodiment.

FIG. 8 is a diagram illustrating an enlarged view of a first fixing roller pair according to the fourth embodiment and the fifth embodiment.

### DESCRIPTION OF EXEMPLARY EMBODIMENTS

Embodiments of the invention will now be described with reference to the drawings.

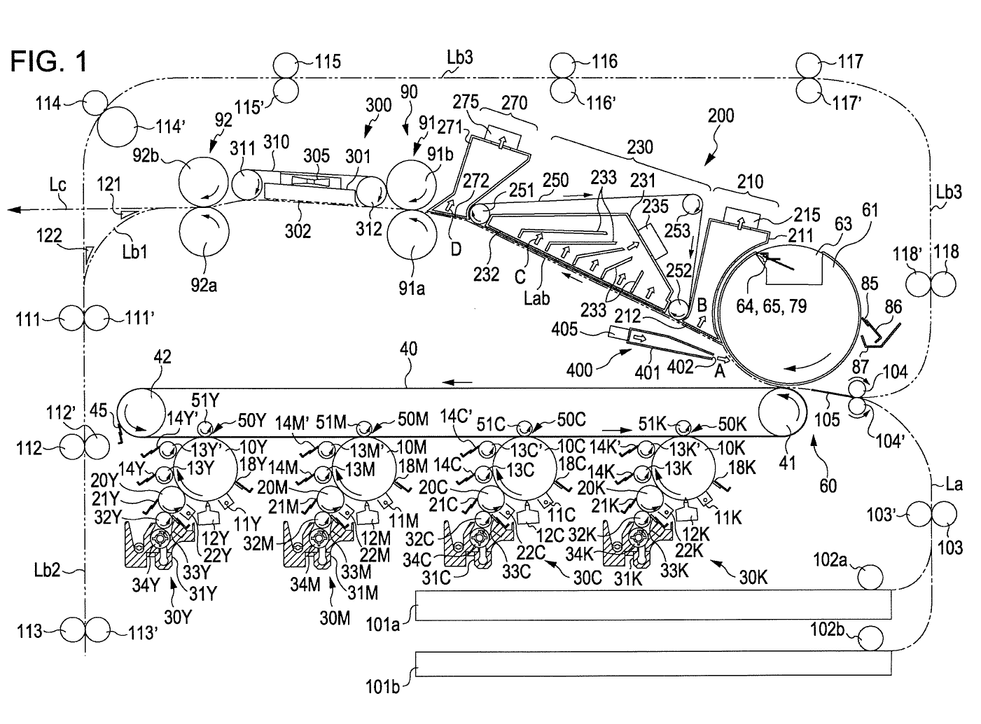

FIG. 1 is a diagram illustrating the primary constituent elements of which an image forming apparatus according to a first embodiment of the invention is configured. Developing units 30Y, 30M, 30C, and 30K, serving as developing units, are disposed in a lower portion of the image forming apparatus, opposing an intermediate transfer belt 40, serving as a transfer medium, disposed in a central portion of the image forming apparatus; a secondary transfer unit 60 serving as a transfer unit, a fixing unit 90 serving as a fixing unit, and so on are disposed in an upper portion of the image forming apparatus. In particular, the fixing unit 90 is laid out above the intermediate transfer belt 40, thereby making it possible to reduce the installation footprint of the image forming apparatus as a whole.

First, units surrounding photosensitive members will be described. Photosensitive members 10Y, 10M, 10C, and 10K, each serving as a latent image bearing member and each configured of a cylindrically-shaped member on the outer circumferential surface of which a photosensitive layer such as an amorphous silicon photosensitive member is formed, are provided, and the following elements are disposed in the respective surrounding areas thereof, following the rotational direction of the outer circumference of the photosensitive members 10Y, 10M, 10C, and 10K and starting with corona charging units 11Y, 11M, 11C, and 11K: exposure units 12Y, 12M, 12C, and 12K; developing rollers 20Y, 20M, 20C, and 20K serving as developer holding members for the developing units 30Y, 30M, 30C, and 30K; first photosensitive member squeeze rollers 13Y, 13M, 13C, and 13K; second photosensitive member squeeze rollers 13Y′, 13M′, 13C′, and 13K′; primary transfer units 50Y, 50M, 50C, and 50K; discharge units (not shown); and photosensitive member cleaning blades 18Y, 18M, 18C, and 18K. Note that in an image formation process, elements disposed earlier in the order from the corona charging units 11Y, 11M, 11C, and 11K to the photosensitive member cleaning blades 18Y, 18M, 18C, and 18K are defined as being upstream from elements disposed later in the stated order.

With the units surrounding the photosensitive members, first, the photosensitive members 10Y, 10M, 10C, and 10K are uniformly charged by the corona charging units 11Y, 11M, 11C, and 11K, which are disposed further upstream in the rotational direction of the photosensitive members 10Y, 10M, 10C, and 10K than nip portions formed between the photosensitive members 10Y, 10M, 10C, and 10K and the developing rollers 20Y, 20M, 20C, and 20K. Then, the exposure units 12Y, 12M, 12C, and 12K, which are disposed downstream from the corona charging units 11Y, 11M, 11C, and 11K and upstream from nip portions formed between the photosensitive members 10Y, 10M, 10C, and 10K and the developing rollers 20Y, 20M, 20C, and 20K, carry out exposure based on inputted image signals, forming electrostatic latent images by irradiating the surfaces of the charged photosensitive members 10Y, 10M, 10C, and 10K.

Next, the developing units 30Y, 30M, 30C, and 30K will be described. In the developing units 30Y, 30M, 30C, and 30K, augers 34Y, 34M, 34C, and 34K that agitate and transport liquid developers of various colors held within developer reservoirs 31Y, 31M, 31C, and 31K supply the liquid developers to anilox rollers 32Y, 32M, 32C, and 32K serving as developer supply members. Next, the anilox rollers 32Y, 32M, 32C, and 32K apply the liquid developers of the respective colors to the developing rollers 20Y, 20M, 20C, and 20K, the amount of the liquid developers having been regulated by regulating blades 33Y, 33M, 33C, and 33K.

The liquid developers held on the developing rollers 20Y, 20M, 20C, and 20K is put into a state of compaction by compaction corona generators 22Y, 22M, 22C, and 22K, after which the electrostatic latent images formed upon the photosensitive members 10Y, 10M, 10C, and 10K are developed and toner images formed upon the photosensitive members 10Y, 10M, 10C, and 10K. Liquid developer that has remained on the developing rollers 20Y, 20M, 20C, and 20K is cleaned off by developing roller cleaning blades 21Y, 21M, 21C, and 21K.

The liquid developer held in the developer reservoir 31Y is a non-volatile liquid developer, which is non-volatile at normal temperatures, and which has a high concentration and high viscosity, rather than a volatile liquid developer that uses Isopar (an Exxon brand) as its carrier, which is volatile at normal temperatures, has a low concentration (approximately 1-3 wt %), and that has a low viscosity, as has generally been used in the past. In other words, the liquid developer in the invention is a high-viscosity liquid developer (that is, a viscoelasticity of approximately 30 to 300 mPa/s at a shear rate of 1000 (1/s) at 25° C., measured using a HAAKE RheoStress RS600) with a toner solid content concentration of approximately 15 to 25%, in which solid particles of a colorant such as a pigment having an average particle diameter of 1 μm are dispersed within a thermoplastic resin and are added to a liquid carrier such as an organic carrier, silicon oil, mineral oil, or cooking oil along with a dispersant.

The toner images formed upon the photosensitive members 10Y, 10M, 10C, and 10K are squeezed by the first photosensitive member squeeze rollers 13Y, 13M, 13C, and 13K and the second photosensitive member squeeze rollers 13Y′, 13M′, 13C′, and 13K′.

The intermediate transfer belt 40 is a belt, formed of a seamless elastic member such as rubber, that is stretched across a belt driving roller 41 and a tension roller 42; the intermediate transfer belt 40 is rotationally driven by the belt driving roller 41 while making contact with the photosensitive members 10Y, 10M, 10C, and 10K at the primary transfer units 50Y, 50M, 50C, and 50K. The primary transfer units 50Y, 50M, 50C, and 50K form a full-color toner image by sequentially transferring the developed toner images of the stated colors upon the photosensitive members 10Y, 10M, 10C, and 10K onto the intermediate transfer belt 40, thereby superimposing the toner images on one another, using the positions where the intermediate transfer belt 40 makes contact with the photosensitive members 10Y, 10M, 10C, and 10K located between the photosensitive members 10Y, 10M, 10C, and 10K and primary transfer rollers 51Y, 51M, 51C, and 51K as the transfer positions.

Liquid developer that has remained on the photosensitive members 10Y, 10M, 10C, and 10K after passing through the primary transfer units 50Y, 50M, 50C, and 50K is removed using a discharge unit (not shown), the photosensitive member cleaning blades 18Y, 18M, 18C, and 18K, and so on.

Note that the disposition order of the photosensitive members, the elements of the developing units, and so on with respect to the Y, M, C, and K colors is not limited to the order illustrated in FIG. 1, and the order may be set as desired.

Next, the transfer of a toner image from the intermediate transfer belt 40 to a transfer material S will be described.

The transfer material S is supplied to the image forming apparatus by a paper supply unit. The transfer material S, which has been set in a first paper supply tray 101a or a second paper supply tray 101b, is transported to a paper supply transport path La at a predetermined timing, one respective sheet at a time, by a first paper supply roller 102a or a second paper supply roller 102b. Meanwhile, in a transfer material transport path Lab, the transfer material S is transported to a secondary transfer position by a pair of gate rollers 104 and 104′ and a transfer material guide 105.

The secondary transfer unit 60 includes a secondary transfer roller 61, serving as a transfer member, and a secondary transfer roller cleaning blade 85 that cleans the secondary transfer roller 61. The secondary transfer roller 61 rotates along with the belt driving roller 41 in the direction indicated by the arrow, and a transfer bias is applied thereto.

The leading edge of the transfer material S transported by the transfer material guide 105 is caught by a gripper 64, serving as a transfer material catching unit provided within a concave portion 63 extending in the axial direction of the secondary transfer roller 61, and a gripper support portion 65, serving as a transfer material catching unit receiving portion on which the gripper 64 is seated; thus the transfer material S is positioned relative to the secondary transfer roller 61 and moves with certainty toward a transfer nip as the secondary transfer roller 61 rotates.

The toner image on the intermediate transfer belt 40 is transferred to the transfer material S, which is paper, film, cloth, or the like, at the transfer nip. When a catching portion of the gripper 64 and the leading edge of the transfer material S pass through the transfer nip, the gripper 64 commences movement in a direction away from a claw seat 65, and the leading edge of the transfer material S is released as a result. Then, a protruding claw 79 is set to a protruding position as the secondary transfer roller 61 rotates further, and thus the transfer material S separates from the secondary transfer roller 61.

Meanwhile, the transfer material S that was released from the gripper 64 is lightly pressed against the secondary transfer roller 61 by air blown from a blowing unit 400 that expels air, in the direction indicated by an arrow A, from an opening portion 402 in a housing unit 401, the air being expelled through the operation of an airflow generation unit 405; the transfer material S is also pressed in a direction away from the secondary transfer roller 61 by the protruding claw 79.

In this manner, the transfer material S gripped by the nip portion between the belt driving roller 41 and the secondary transfer roller 61 moves to a transfer material transport unit 200, in order from the leading edge to the following edge, due to further rotation of the belt driving roller 41 and the secondary transfer roller 61. In other words, the portion of the transfer material S for which transfer is complete separates while the toner image on the intermediate transfer belt 40 undergoes the secondary transfer onto the transfer material S.

According to this configuration, it is possible to prevent the following edge of the transfer material S from making contact with the intermediate transfer belt 40 or the like and the image formed thereupon being soiled, when the following edge of the transfer material S is discharged from a secondary transfer nip. Note that the air blowing performed by the blowing unit 400 may be omitted in the case where the transfer material S has a low elastic restitution force and is flimsy.

Next, transport of the post-secondary transfer transfer material S will be described.

A first suction device 210, a transfer material transport device 230, and a second suction device 270 are disposed in that order, as the transfer material transport unit 200, downstream from the secondary transfer unit 60 in the transfer material transport path Lab, and serve to transport the transfer material S to the fixing unit 90.

The post-secondary transfer transfer material S is held on a suction surface 212 of a housing portion 211, without falling, as a result of a suction force B from the suction surface 212 that is generated through the operation of an airflow generation unit 215 of the first suction device 210, and is transported along the suction surface 212, by the force of a feeding operation, from the side of the secondary transfer unit 60.

As a result of the force of the feeding operation from the side of the secondary transfer unit 60, the transfer material S transported along the suction surface 212 of the first suction device 210 reaches the side of the transfer material transport device 230. Next, the transfer material S is held against a transport surface by a suction force C, from a suction surface 232 of a housing portion 231, that is generated through the operation of an airflow generation unit 235 of the transfer material transport device 230. Along with this, the transfer material S advances along the transport surface toward the fixing unit 90 as a result of a transfer material transport member 250, which is wound upon a transfer material transport member driving roller 251 and transfer material transport member support rollers 252 and 253, performing moving operations due to driving force exerted by the transfer material transport member driving roller 251.

The transfer material S that has been transported along the transport surface of the transfer material transport device 230 is sucked as a result of a suction force D, from a suction surface 272 of a housing portion 271, generated through operations performed by an airflow generation unit 275 of the second suction device 270, and is transported thus.

Next, fixing of the toner image onto the transfer material S will be described.

In the fixing unit 90, a single-color toner image, a full-color toner image, or the like that has been transferred onto the transfer material S, such as paper or the like, is bonded and fixed to the transfer material S, such as paper or the like.

The fixing unit 90 includes a first fixing roller pair 91 serving as a first fixing unit, and a second fixing roller pair 92, serving as a second fixing unit, located downstream from the first fixing roller pair 91. The first fixing roller pair 91 includes a first heating roller 91a, serving as a first heating unit, that has an internal heater, and a first pressure roller 91b, serving as a first pressure unit, that is biased at a predetermined pressure toward the first heating roller 91a; the transfer material S enters into a nip formed by these rollers, where a single-color toner image, a full-color toner image, or the like transferred onto the transfer material S is bonded and fixed to the transfer material S, which is paper or the like. Likewise, the second fixing roller pair 92 includes a second heating roller 92a, serving as a second heating unit, that has an internal heater, and a second pressure roller 92b, serving as a second pressure unit, that is biased at a predetermined pressure toward the second heating roller 92a; the transfer material S enters into a nip formed by these rollers, where the single-color toner image, the full-color toner image, or the like transferred into the transfer material S is bonded and fixed with further strength to the transfer material S, which is paper or the like.

Furthermore, a fixing unit suction guide 300 is disposed between the first fixing roller pair 91 and the second fixing roller pair 92 of the fixing unit 90. The fixing unit suction guide 300 includes a housing portion 301, a fixing unit suction surface 302 disposed on the transfer material transport path Lab side of the housing portion 301, and an airflow generation unit 305 disposed in the housing portion 301 on the side opposite to the transfer material transport path Lab; the transfer material S is held on the fixing unit suction surface 302 without falling by a suction force E, from the fixing unit suction surface 302 of the housing portion 301, generated through the operation of the airflow generation unit 305, and is transported along the fixing unit suction surface 302, while being held thereon, toward the second fixing roller pair 92 by the force of the feeding operation from the first fixing roller pair 91.

After the fixing, in the case of single-sided printing, the transfer material S is transported along a discharge transport path Lc and is discharged.

On the other hand, in the case of double-sided printing, the transfer material S is guided by a first flapper 121, and is transported to a first double-sided transport path Lb1. After this, the transport direction of the transfer material S is inverted in a second double-sided transport path Lb2 having a first inversion transport roller pair 111 and 111′, a second inversion transport roller pair 112 and 112′, and a third inversion transport roller pair 113 and 113′, after which the transfer material S is guided by a second flapper 122 and transported to a third double-sided transport path Lb3.

In the third double-sided transport path Lb3, the transfer material S passes through a curl application roller pair 114 and 114′ serving as a curl application unit, and then passes through a first double-sided transport roller pair 115 and 115′, a second double-sided transport roller pair 116 and 116′, a third double-sided transport roller pair 117 and 117′, and a fourth double-sided transport roller pair 118 and 118′. Next, the inverted transfer material S is transported from the pair of gate rollers 104 and 104′ and the transfer material guide 105 to the transfer material transport path Lab. After this, the transfer material S passes through the fixing unit 90, is transported to the discharge transport path Lc, and is discharged.

Detailed descriptions of the fixing unit 90 will be given hereinafter.

The first heating roller 91a and the second heating roller 92a of the first embodiment are 60 mm in diameter; the metal cores thereof are 2 mm in thickness, and the material of the metal cores is aluminum, iron, stainless steel, brass, or the like. An elastic layer is formed around the circumference of the respective metal cores. The thickness of the elastic layer is 2 mm, and the material of the elastic layer is silicon rubber, fluorocarbon rubber, urethane rubber, or the like. Furthermore, a delamination layer is formed around the elastic layer. The delamination layer is 30 μm thick, and the material of the delamination layer is PFA, PTFE, FEP, ETFE, or the like.

Furthermore, the first pressure roller 91b and the second pressure roller 92b of the first embodiment are 60 mm in diameter; the metal cores thereof are 2 mm in thickness, and the material of the metal cores is aluminum, iron, stainless steel, brass, or the like. An elastic layer is formed around the circumference of the respective metal cores. The thickness of the elastic layer is 2 mm, and the material of the elastic layer is silicon rubber, fluorocarbon rubber, urethane rubber, or the like. Furthermore, a delamination layer is formed around the elastic layer. The delamination layer is 30 μm thick, and the material of the delamination layer is PFA, PTFE, FEP, ETFE, or the like.

In addition, the first heating roller 91a and the second heating roller 92a are driven by a driving member (not shown), and the first pressure roller 91b and the second pressure roller 92b rotate as slaves based on the rotation of the first heating roller 91a and the second heating roller 92a, respectively.

Note that in the case where a rigid material such as iron, aluminum, stainless steel, brass, or the like is used for the first pressure roller 91b and the second pressure roller 92b, and a soft material such a rubber layer made from silicon rubber, urethane rubber, or natural rubber, or a sponge layer made from a silicon sponge, a urethane sponge, or a melamine sponge is provided on the shafts of the first heating roller 91a and the second heating roller 92a, curling in the direction of the image surface caused by heat can be corrected. In addition, it is not necessary for the second heating roller 92a and the second pressure roller 92b to separate from each other completely; the rollers may be formed so that the applied pressure is reduced, rather than separating from each other completely.

Next, the fixing unit suction guide 300 will de described in detail. The fixing unit suction guide 300 according to this embodiment is disposed so that the side of the fixing unit suction guide 300 toward the second fixing roller pair 92 is higher in the vertical direction relative to an imaginary line H that connects a first nip portion of the first fixing roller pair 91 and a second nip portion of the second fixing roller pair 92.

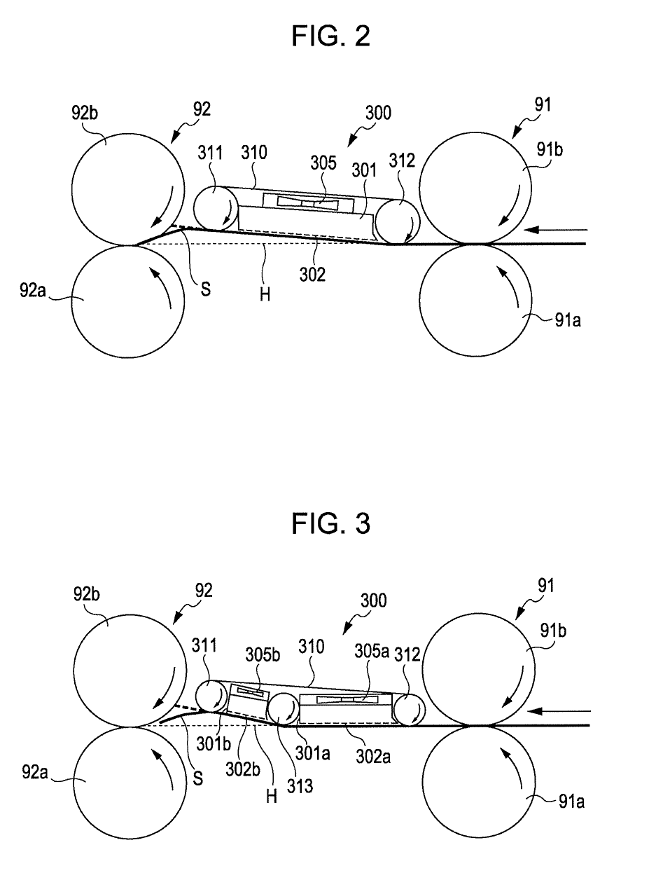

FIG. 2 is a diagram illustrating the fixing unit suction guide 300 according to the first embodiment.

The fixing unit suction guide 300 of the first embodiment includes: the housing portion 301; the fixing unit suction surface 302, disposed in the side of the housing portion 301 toward the transfer material transport path Lab; the airflow generation unit 305 disposed in the side of the housing portion 301 that is opposite to the transfer material transport path Lab; a fixing unit transport belt 310; and a driving shaft 311 and a slave shaft 312 around which the fixing unit transport belt 310 is wound.

With this fixing unit suction guide 300, the transfer material S is held on the fixing unit suction surface 302 without dropping as a result of the suction force from the fixing unit suction surface 302 of the housing portion 301 generated through the operation of the airflow generation unit 305; the fixing unit transport belt 310 rotates as a result of the driving shaft 311 being driven by a driving unit (not shown), and the transfer material S is transported toward the second fixing roller pair 92 along the fixing unit suction surface 302.

The fixing unit suction guide 300 is disposed so that the side of the fixing unit suction guide 300 toward the second fixing roller pair 92 is higher in the vertical direction relative to the imaginary line H that connects the first nip portion of the first fixing roller pair 91 and the second nip portion of the second fixing roller pair 92. In the first embodiment, the fixing unit suction guide is sloped by approximately 5° to 30° relative to the horizontal line.

Meanwhile, the fixing unit transport belt 310 includes holes through which air passes, and moves along the fixing unit suction surface 302.

By using the fixing unit suction guide 300 in this manner, the amount of moisture contained in the transfer material S is rapidly reduced by subjecting the transfer material S to a large amount of air, thus making it possible to correct curling. Accordingly, it is no longer necessary to provide a curl roller pair as was done in the past, thus making it possible to reduce the size of the image forming apparatus. Furthermore, collisions between the leading edge of the transfer material S and the second heating roller 92a can be reduced by sucking the transfer material S using the fixing unit suction guide 300.

Meanwhile, because the fixing unit suction guide 300 is disposed so that the side of the fixing unit suction guide 300 toward the second fixing roller pair 92 is higher in the vertical direction relative to the imaginary line H that connects the first nip portion of the first fixing roller pair 91 and the second nip portion of the second fixing roller pair 92, even if the transfer material S sags in downward in the vertical direction due to the influence of gravity after being discharged from the fixing unit suction guide 300, a setting can be made so that the non-printed surface thereof makes contact with the second pressure roller 92b instead of the printed surface thereof colliding with the second heating roller 92a; this makes it possible to reduce defects in the image.

FIG. 3 is a diagram illustrating the fixing unit suction guide 300 according to a second embodiment.

The fixing unit suction guide 300 according to the second embodiment includes: a first housing portion 301a; a first fixing unit suction surface 302a disposed in the first housing portion 301a on the side toward the transfer material transport path Lab; a first airflow generation unit 305a disposed in the first housing portion 301a on the side opposite to the transfer material transport path Lab; a second housing portion 301b; a second fixing unit suction surface 302b disposed in the second housing portion 301b on the side toward the transfer material transport path Lab; a second airflow generation unit 305b disposed in the second housing portion 301b on the side opposite to the transfer material transport path Lab; the fixing unit transport belt 310; the driving shaft 311 and a first slave shaft 312 around which the fixing unit transport belt 310 is wound; and a second slave shaft 313 disposed between the first housing portion 301a and the second housing portion 301b.

With this fixing unit suction guide 300, the transfer material S is held on the first fixing unit suction surface 302a and the second fixing unit suction surface 302b without dropping as a result of the suction force from the first fixing unit suction surface 302a of the first housing portion 301a and the second fixing unit suction surface 302b of the second housing portion 301b generated through the operations of the first airflow generation unit 305a and the second airflow generation unit 305b; the fixing unit transport belt 310 rotates as a result of the driving shaft 311 being driven by a driving unit (not shown), and the transfer material S is transported toward the second fixing roller pair 92 along the first fixing unit suction surface 302a and the second fixing unit suction surface 302b.

The fixing unit suction guide 300 is disposed so that the side of the fixing unit suction guide 300 toward the second fixing roller pair 92 is higher in the vertical direction relative to the imaginary line H that connects the first nip portion of the first fixing roller pair 91 and the second nip portion of the second fixing roller pair 92. As shown in FIG. 3, in the second embodiment, the first fixing unit suction surface 302a on the side toward the first fixing roller pair 91 is formed so as to be horizontal, whereas the second fixing unit suction surface 302b on the side toward the second fixing roller pair 92 is formed with a slope so as to be higher in the vertical direction.

Meanwhile, the fixing unit transport belt 310 includes holes through which air passes, and moves along the fixing unit suction surface 302.

By using the fixing unit suction guide 300 in this manner, the amount of moisture contained in the transfer material S is rapidly reduced by subjecting the transfer material S to a large amount of air, thus making it possible to correct curling. Accordingly, it is no longer necessary to provide a curl roller pair as was done in the past, thus making it possible to reduce the size of the image forming apparatus. Furthermore, collisions between the leading edge of the transfer material S and the second heating roller 92a can be reduced by sucking the transfer material S using the fixing unit suction guide 300.

Meanwhile, because the fixing unit suction guide 300 is disposed so that the side of the fixing unit suction guide 300 toward the second fixing roller pair 92 is higher in the vertical direction relative to the imaginary line H that connects the first nip portion of the first fixing roller pair 91 and the second nip portion of the second fixing roller pair 92, even if the transfer material S sags in downward in the vertical direction due to the influence of gravity after being discharged from the fixing unit suction guide 300, a setting can be made so that the non-printed surface thereof makes contact with the second pressure roller 92b instead of the printed surface thereof colliding with the second heating roller 92a; this makes it possible to reduce defects in the image.

FIG. 5 is a diagram illustrating the fixing unit suction guide 300 according to a third embodiment.

The fixing unit suction guide 300 of the third embodiment includes: the housing portion 301; the fixing unit suction surface 302, disposed in the side of the housing portion 301 toward the transfer material transport path Lab; and the airflow generation unit 305 disposed in the side of the housing portion 301 that is opposite to the transfer material transport path Lab.

With this fixing unit suction guide 300, the transfer material S is held on the fixing unit suction surface 302 without dropping as a result of the suction force from the fixing unit suction surface 302 of the housing portion 301 generated through the operation of the airflow generation unit 305; the transfer material S is transported toward the second fixing roller pair 92 along the fixing unit suction surface 302 due to the rotation of the first fixing roller pair 91.

The fixing unit suction guide 300 is disposed so that the side of the fixing unit suction guide 300 toward the second fixing roller pair 92 is higher in the vertical direction relative to the imaginary line H that connects the first nip portion of the first fixing roller pair 91 and the second nip portion of the second fixing roller pair 92. As shown in FIG. 5, in the third embodiment, a first fixing unit suction surface 302 on the side toward the first fixing roller pair 91 is formed so as to be horizontal, whereas a second fixing unit suction surface 302 on the side toward the second fixing roller pair 92 is formed with a slope so as to be higher in the vertical direction, as in the second embodiment.

By using the fixing unit suction guide 300 in this manner, the amount of moisture contained in the transfer material S is rapidly reduced by subjecting the transfer material S to a large amount of air, thus making it possible to correct curling. Accordingly, it is no longer necessary to provide a curl roller pair as was done in the past, thus making it possible to reduce the size of the image forming apparatus. Furthermore, collisions between the leading edge of the transfer material S and the second heating roller 92a can be reduced by sucking the transfer material S using the fixing unit suction guide 300.

Meanwhile, because the fixing unit suction guide 300 is disposed so that the side of the fixing unit suction guide 300 toward the second fixing roller pair 92 is higher in the vertical direction relative to the imaginary line H that connects the first nip portion of the first fixing roller pair 91 and the second nip portion of the second fixing roller pair 92, even if the transfer material S sags in downward in the vertical direction due to the influence of gravity after being discharged from the fixing unit suction guide 300, a setting can be made so that the non-printed surface thereof makes contact with the second pressure roller 92b instead of the printed surface thereof colliding with the second heating roller 92a; this makes it possible to reduce defects in the image.

The first heating roller 91a and the first pressure roller 91b of the second embodiment and the third embodiment are 60 mm in diameter; the metal cores thereof are 2 mm in thickness, and the material of the metal cores is aluminum, iron, stainless steel, brass, or the like. An elastic layer is formed around the circumference of the respective metal cores. The thickness of the elastic layer is 2 mm, and the material of the elastic layer is silicon rubber, fluorocarbon rubber, urethane rubber, or the like. Furthermore, a delamination layer is formed around the elastic layer. The delamination layer is 30 μm thick, and the material of the delamination layer is PFA, PTFE, FEP, ETFE, or the like. The roller hardness is the Asker type C measurement of 20 points.

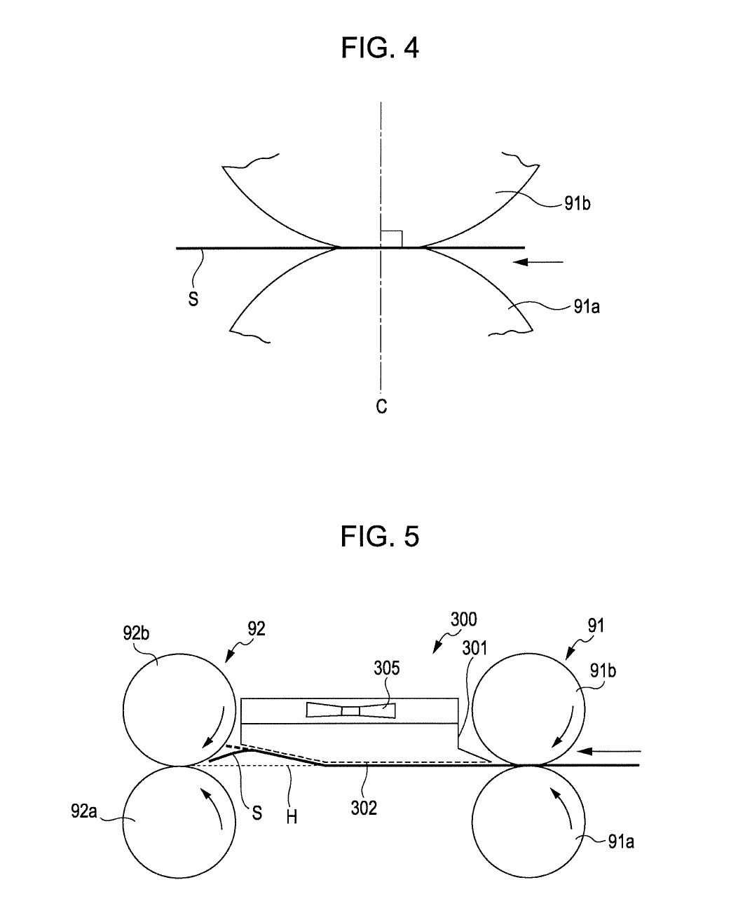

Meanwhile, the first heating roller 91a and the first pressure roller 91b have the same or approximately the same hardness, and thus the first nip portion formed by the first heating roller 91a and the first pressure roller 91b configures a horizontal nip that is essentially perpendicular to a line C that connects the centerlines of the first heating roller 91a and the first pressure roller 91b, as shown in FIG. 4. Note that the distance between a line extending from the horizontal nip and the fixing unit suction surface 302 is set to approximately 0 to 5 mm. The first heating roller 91a and the first pressure roller 91b apply pressure at a loading of 10 to 80 kgf. Here, “the same or approximately the same hardness” refers to ±5 points in the same Asker type C hardness.

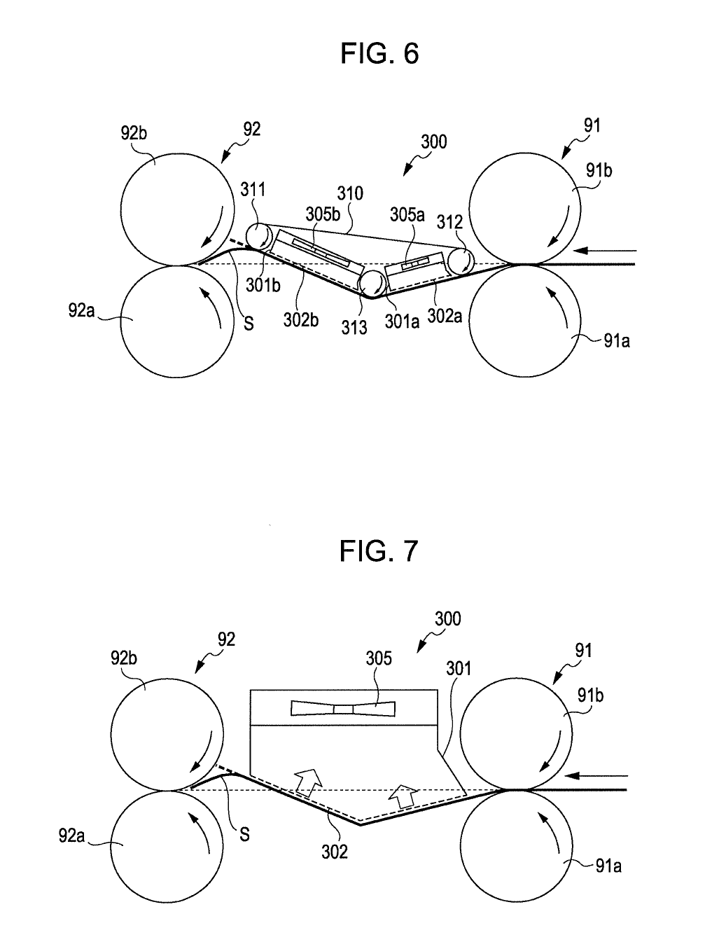

FIG. 6 is a diagram illustrating the fixing unit suction guide 300 according to a fourth embodiment.

The fixing unit suction guide 300 according to the fourth embodiment includes: the first housing portion 301a; the first fixing unit suction surface 302a disposed in the first housing portion 301a on the side toward the transfer material transport path Lab; the first airflow generation unit 305a disposed in the first housing portion 301a on the side opposite to the transfer material transport path Lab; the second housing portion 301b; the second fixing unit suction surface 302b disposed in the second housing portion 301b on the side toward the transfer material transport path Lab; the second airflow generation unit 305b disposed in the second housing portion 301b on the side opposite to the transfer material transport path Lab; the fixing unit transport belt 310; the driving shaft 311 and the first slave shaft 312 around which the fixing unit transport belt 310 is wound; and the second slave shaft 313 disposed between the first housing portion 301a and the second housing portion 301b.

With this fixing unit suction guide 300, the transfer material S is held on the first fixing unit suction surface 302a and the second fixing unit suction surface 302b without dropping as a result of the suction force from the first fixing unit suction surface 302a of the first housing portion 301a and the second fixing unit suction surface 302b of the second housing portion 301b generated through the operations of the first airflow generation unit 305a and the second airflow generation unit 305b; the fixing unit transport belt 310 rotates as a result of the driving shaft 311 being driven by a driving unit (not shown), and the transfer material S is transported toward the second fixing roller pair 92 along the first fixing unit suction surface 302a and the second fixing unit suction surface 302b.

The fixing unit suction guide 300 is disposed so that the side of the fixing unit suction guide 300 toward the second fixing roller pair 92 is higher in the vertical direction relative to the imaginary line H that connects the first nip portion of the first fixing roller pair 91 and the second nip portion of the second fixing roller pair 92. In the fourth embodiment, the first fixing unit suction surface 302a on the side toward the first fixing roller pair 91 is formed so as to slope toward the printed surface and thus be lower in the vertical direction, whereas the second fixing unit suction surface 302b on the side toward the second fixing roller pair 92 is formed so as to slope away from the printed surface and thus be higher in the vertical direction.

Meanwhile, the fixing unit transport belt 310 includes holes through which air passes, and moves along the fixing unit suction surface 302.

By using the fixing unit suction guide 300 in this manner, the amount of moisture contained in the transfer material S is rapidly reduced by subjecting the transfer material S to a large amount of air, thus making it possible to correct curling. Accordingly, it is no longer necessary to provide a curl roller pair as was done in the past, thus making it possible to reduce the size of the image forming apparatus. Furthermore, collisions between the leading edge of the transfer material S and the second heating roller 92a can be reduced by sucking the transfer material S using the fixing unit suction guide 300.

Meanwhile, because the fixing unit suction guide 300 is disposed so that the side of the fixing unit suction guide 300 toward the second fixing roller pair 92 is higher in the vertical direction relative to the imaginary line H that connects the first nip portion of the first fixing roller pair 91 and the second nip portion of the second fixing roller pair 92, even if the transfer material S sags in downward in the vertical direction due to the influence of gravity after being discharged from the fixing unit suction guide 300, a setting can be made so that the non-printed surface thereof makes contact with the second pressure roller 92b instead of the printed surface thereof colliding with the second heating roller 92a; this makes it possible to reduce defects in the image.

FIG. 7 is a diagram illustrating the fixing unit suction guide 300 according to a fifth embodiment.

The fixing unit suction guide 300 of the fifth embodiment includes: the housing portion 301; the fixing unit suction surface 302, disposed in the side of the housing portion 301 toward the transfer material transport path Lab; and the airflow generation unit 305 disposed in the side of the housing portion 301 that is opposite to the transfer material transport path Lab.

With this fixing unit suction guide 300, the transfer material S is held on the fixing unit suction surface 302 without dropping as a result of the suction force from the fixing unit suction surface 302 of the housing portion 301 generated through the operation of the airflow generation unit 305; the transfer material S is transported toward the second fixing roller pair 92 along the fixing unit suction surface 302 due to the rotation of the first fixing roller pair 91.

The fixing unit suction guide 300 is disposed so that the side of the fixing unit suction guide 300 toward the second fixing roller pair 92 is higher in the vertical direction relative to the imaginary line H that connects the first nip portion of the first fixing roller pair 91 and the second nip portion of the second fixing roller pair 92. In the fifth embodiment, the first fixing unit suction surface 302a on the side toward the first fixing roller pair 91 is formed so as to slope toward the printed surface and thus be lower in the vertical direction, whereas the second fixing unit suction surface 302b on the side toward the second fixing roller pair 92 is formed so as to slope away from the printed surface and thus be higher in the vertical direction.

By using the fixing unit suction guide 300 in this manner, the amount of moisture contained in the transfer material S is rapidly reduced by subjecting the transfer material S to a large amount of air, thus making it possible to correct curling. Accordingly, it is no longer necessary to provide a curl roller pair as was done in the past, thus making it possible to reduce the size of the image forming apparatus. Furthermore, collisions between the leading edge of the transfer material S and the second heating roller 92a can be reduced by sucking the transfer material S using the fixing unit suction guide 300.

Meanwhile, because the fixing unit suction guide 300 is disposed so that the side of the fixing unit suction guide 300 toward the second fixing roller pair 92 is higher in the vertical direction relative to the imaginary line H that connects the first nip portion of the first fixing roller pair 91 and the second nip portion of the second fixing roller pair 92, even if the transfer material S sags in downward in the vertical direction due to the influence of gravity after being discharged from the fixing unit suction guide 300, a setting can be made so that the non-printed surface thereof makes contact with the second pressure roller 92b instead of the printed surface thereof colliding with the second heating roller 92a; this makes it possible to reduce defects in the image.

The first heating roller 91a of the fourth embodiment and the fifth embodiment is 60 mm in diameter; the metal core thereof is 2 mm in thickness, and the material of the metal core is aluminum, iron, stainless steel, brass, or the like. An elastic layer is formed around the circumference of the metal core. The thickness of the elastic layer is 2 mm, and the material of the elastic layer is silicon rubber, fluorocarbon rubber, urethane rubber, or the like. Furthermore, a delamination layer is formed around the elastic layer. The delamination layer is 30 μm thick, and the material of the delamination layer is PFA, PTFE, FEP, ETFE, or the like. The roller hardness is the Asker type C measurement of 20 points.

The first pressure roller 91b of the fourth embodiment and the fifth embodiment has an elastic layer thickness of 5 mm, but the rest of the specifications are the same as those of the first heating roller 91a.

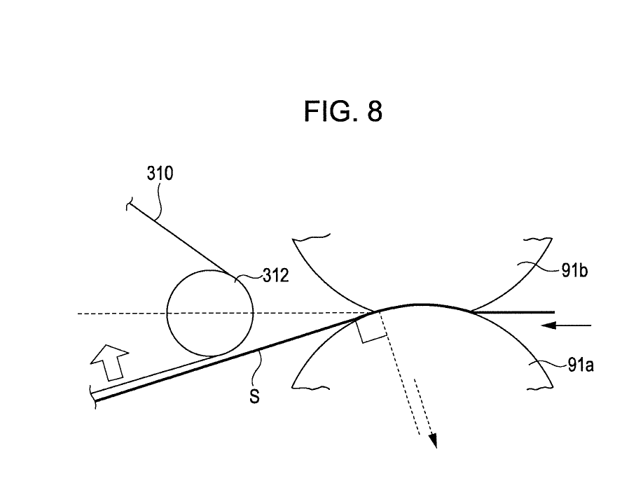

Meanwhile, in the case where the roller hardness of the first heating roller 91a is greater than the roller hardness of the first pressure roller 91b, as in the fourth embodiment and the fifth embodiment, the first nip portion formed by the first heating roller 91a and the first pressure roller 91b takes on a convex shape in the upward direction, as shown in FIG. 8. Note that the first fixing unit suction surface 302a is disposed parallel or approximately parallel to a line of contact at the nip exit of the first heating roller 91a. The distance between the line of contact and the fixing unit suction surface 302 is set to approximately 0 to 5 mm. The first heating roller 91a and the first pressure roller 91b apply pressure at a loading of 10 to 80 kgf.

In this manner, according to the fixing unit 90 of the embodiments, the influence of the second fixing roller pair 92 on the image surface can be reduced using a simple configuration. In addition, according to the image forming apparatus of these embodiments, the influence of the second fixing roller pair 92 on the image surface can be reduced using a simple configuration, thus making it possible to form a favorable image.

In addition, the fixing unit suction guide 300, in which the end of the suction surface 302 on the side toward the second fixing unit in the transport direction of the transfer material S is located higher in the vertical direction than an imaginary line that connects the first nip portion and the second nip portion, is provided, and thus the transfer material S can move to the second nip portion of the second fixing roller pair 92 in a smooth manner.

In addition, because the side of the suction surface 302 toward the first fixing unit is parallel or approximately parallel to the imaginary line, the transfer material S can move to the fixing unit suction guide 300 in a smooth manner.

In addition, because the side of the suction surface 302 toward the first fixing unit is sloped downward in the vertical direction beyond the imaginary line, the transfer material S can move to the fixing unit suction guide 300 in a smooth manner.

In addition, because the fixing unit transport belt 310 that forms the suction surface 302 and transports the transfer material S that has undergone fixing in the first fixing unit, the driving shaft 311 upon which the fixing unit transport belt 310 is stretched and that drives the fixing unit transport belt 310, and the slave shaft 312 upon which the fixing unit transport belt 310 is stretched are provided, the transfer material S sticks to the fixing unit transport belt 310 and the transfer material S and fixing unit transport belt 310 move together; as a result, the transfer material S can be transported from the first fixing roller pair 91 toward the second fixing roller pair 92 in a stable manner.

Furthermore, because the fixing unit transport belt 310 includes the holes 310a through which air flows, the transfer material S can be transported in an even more stable manner.

The entire disclosure of Japanese Patent Application No: 2009-226425, filed Sep. 30, 2009 is expressly incorporated by reference herein.

What is claimed is:

1. A fixing apparatus comprising:
a first fixing unit including a first heating unit that applies heat to a transfer material onto which an image has been transferred and a first pressure unit that forms a first nip portion by pressing against the first heating unit;
a second fixing unit including a second heating unit that applies heat to the transfer material fixed in the first fixing unit and a second pressure unit that forms a second nip portion by pressing against the second heating unit; and
a fixing unit suction guide, including a suction surface that sucks the transfer material fixed in the first fixing unit upward in a vertical direction with a surface of the transfer material onto which the image has been transferred facing downward in the vertical direction, an end of the suction surface on a side toward the second fixing unit in a transport direction of the transfer material being located higher in the vertical direction than an imaginary line that connects the first nip portion and the second nip portion.

2. An image forming apparatus comprising:
a latent image bearing member on which a latent image is formed;
a developing unit that develops the latent image on the latent image bearing member using a liquid developer containing toner particles and a carrier liquid;
a transfer medium onto which the image developed on the latent image bearing member by the developing unit is transferred;
a transfer roller that makes contact with the transfer medium and forms a transfer nip portion therewith, and that transfers the image onto a transfer material;
a first fixing unit including a first heating unit that applies heat to the transfer material onto which the image has been transferred and a first pressure unit that forms a first nip portion by pressing against the first heating unit;
a second fixing unit including a second heating unit that applies heat to the transfer material fixed in the first fixing unit and a second pressure unit that forms a second nip portion by pressing against the second heating unit; and
a fixing unit suction guide, including a suction surface that sucks the transfer material fixed in the first fixing unit upward in the vertical direction with a surface of the transfer material onto which the image has been transferred facing downward in the vertical direction, an end of the suction surface on a side toward the second fixing unit in a transport direction of the transfer material being located higher in the vertical direction than an imaginary line that connects the first nip portion and the second nip portion.

3. The image forming apparatus according to claim 2, wherein a side of the suction surface toward the first fixing unit is parallel or approximately parallel to the imaginary line.

4. The image forming apparatus according to claim 3, wherein the first heating unit is a heating roller in which has an elastic layer, and the first pressure unit is a pressure roller whose surface hardness is the same or approximately the same as a surface hardness of the heating roller.

5. The image forming apparatus according to claim 2, wherein the side of the suction surface toward the first fixing unit is sloped downward in the vertical direction beyond the imaginary line.

6. The image forming apparatus according to claim 2, further comprising:
a transport belt that forms the suction surface and transports the transfer material fixed in the first fixing unit;
a driving roller, upon which the transport belt is wound, that drives the transport belt; and
a slave roller upon which the transport belt is stretched.

7. The image forming apparatus according to claim 6, wherein the transport belt has a hole through which air flows.
